(19) United States
(12) Patent Application Publication
(10) Pub. No.: US 2024/0057175 A1
(43) Pub. Date: Feb. 15, 2024

(54) TERMINAL, RADIO COMMUNICATION METHOD, AND BASE STATION

(71) Applicant: NTT DOCOMO, INC., Tokyo (JP)

(72) Inventors: Shinya Kumagai, Tokyo (JP); Satoshi Nagata, Tokyo (JP)

(73) Assignee: NTT DOCOMO, INC., Tokyo (JP)

(21) Appl. No.: 18/271,816

(22) PCT Filed: Jan. 24, 2022
(86) PCT No.: PCT/JP2022/002333

§ 371 Date: Jul. 11, 2023

(30) Foreign Application Priority Data
Jan. 25, 2021 (JP) 2021-009744

(51) Int. Cl. H04W 74/08

(52) U.S. Cl. CPC H04W 74/085

(57) ABSTRACT

A terminal according to one aspect of the present disclosure includes a receiving section that receives configuration information related to channel occupancy time (COT) in a semistatic channel access procedure and configuration information related to a physical random access channel (PRACH), via higher layer signaling, and a control section that controls initiation of the COT, based on the configuration information related to the COT, and controls PRACH transmission in a PRACH transmission opportunity in the COT, based on the configuration information related to the PRACH. According to one aspect of the present disclosure, radio communication in an NR-U system can be appropriately controlled.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+ (plus),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, also referred to as 5G, 5G+, New Radio (NR), 3GPP Rel. 16 or later versions, or the like), use of an unlicensed band (which may be referred to as an NR-Unlicensed (U) system) has been under study as in the case of existing radio communication systems (for example, 3GPP Rel. 15 or earlier versions).

In the future radio communication systems (for example, also referred to as 5G, 5G+, New Radio (NR), 3GPP Rel. 16 or later versions, or the like), introduction of downlink control information (DCI) formats (for example, DCI formats 0_2 and 1_2) for a traffic type such as high-reliable and low-latency communication (for example, Ultra-Reliable and Low-Latency Communications (URLLC)) has been under study.

However, a full study has not been carried out on user terminal (terminal, User Equipment (UE))-initiated (UE-initiated) channel occupancy time (COT) for FBE (frame-based equipment) in uplink communication in a traffic type such as URLLC.

In view of this, the present disclosure has one object to provide a terminal, a radio communication method, and a base station, with which radio communication in an NR-U system can be appropriately controlled.

### Solution to Problem

A terminal according to one aspect of the present disclosure includes a receiving section that receives configuration information related to channel occupancy time (COT) in a semi-static channel access procedure and configuration information related to a physical random access channel (PRACH), via higher layer signaling, and a control section that controls initiation of the COT, based on the configuration information related to the COT, and controls PRACH transmission in a PRACH transmission opportunity in the COT, based on the configuration information related to the PRACH.

### Advantageous Effects of Invention

According to one aspect of the present disclosure, radio communication in an NR-U system can be appropriately controlled.

### BRIEF DESCRIPTION OF DRAWINGS

FIG. 1 is a diagram to show an example of base station-initiated COT in Rel. 16.

FIG. 2 is a diagram to show an example of obtaining UE-initiated COT.

FIG. 3 is a diagram to show an example of a PRACH transmission period in COT according to a first embodiment.

FIG. 4 is a diagram to show an example of a PRACH transmission period in COT according to a second embodiment.

FIG. 5 is a diagram to show an example of a schematic structure of a radio communication system according to one embodiment.

FIG. 6 is a diagram to show an example of a structure of a base station according to one embodiment.

FIG. 7 is a diagram to show an example of a structure of a user terminal according to one embodiment.

FIG. 8 is a diagram to show an example of a hardware structure of the base station and the user terminal according to one embodiment.

### DESCRIPTION OF EMBODIMENTS

### (Services (Traffic Types))

In future radio communication systems (for example, NR), traffic types (also referred to as types, services, service types, communication types, use cases, or the like), such as further enhancement of mobile broadband (for example, enhanced Mobile Broadband (eMBB)), machine type communication that implements multiple simultaneous connection (for example, massive Machine Type Communications (mMTC), Internet of Things (IoT)), and high-reliable and low-latency communication (for example, Ultra-Reliable and Low-Latency Communications (URLLC)), are assumed. For example, in URLLC, lower latency and higher reliability in comparison to eMBB are required.

The traffic type may be identified based on at least one of the following in a physical layer.
Logical channel having different priority
Modulation and coding scheme (MCS) table (MCS index table)
Channel quality indication (CQI) table
DCI format
(Radio network temporary indicator (RNTI (System Information-Radio Network Temporary Identifier))) used for scrambling (masking) of cyclic redundancy check (CRC) bits included in (added to) the DCI (DCI format)
RRC (Radio Resource Control) parameter
Specific RNTI (for example, an RNTI for URLLC, an MCS-C-RNTI, or the like)
Search space
Certain field in DCI (for example, a newly added field or reuse of an existing field)

Specifically, the traffic type of a HARQ-ACK (or a PUCCH) for a PDSCH may be determined based on at least one of the following.
An MCS index table used for determination of at least one of a modulation order, a target code rate, and a transport block size (TBS) of the PDSCH (for example, whether or not an MCS index table 3 is used)
An RNTI used for CRC scrambling of DCI used for scheduling of the PDSCH (for example, which of a C-RNTI or an MCS-C-RNTI is used for the CRC scrambling)
Priority configured using higher layer signaling

In the present disclosure, the higher layer signaling may be, for example, any one of Radio Resource Control (RRC) signaling, Medium Access Control (MAC) signaling, broadcast information, and the like, or a combination of these.

As the MAC signaling, for example, a MAC control element (MAC CE), a MAC Protocol Data Unit (PDU), or the like may be used. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

The traffic type may be associated with communication requirements (requirements or required conditions such as latency and an error rate), a data type (voice, data, or the like), and the like.

The difference between requirements of URLLC and requirements of eMBB may be that latency of URLLC is lower than latency of eMBB, or may be that the requirements of URLLC include requirements of reliability.

For example, requirements of user (U) plane latency of eMBB may include requirements that downlink U plane latency is 4 ms and uplink U plane latency is 4 ms. In contrast, requirements of U plane latency of URLLC may include requirements that downlink U plane latency is 0.5 ms and uplink U plane latency is 0.5 ms. Requirements of reliability of URLLC may include requirements that a 32-byte error rate is 10-5 in U plane latency of 1 ms.

As enhanced Ultra Reliable and Low Latency Communications (eURLLC), mainly, enhancement of reliability of traffic for unicast data has been under study. URLLC and eURLLC are hereinafter simply referred to as URLLC when not being distinguished from each other.

In NR of Rel. 16 or later versions, configuration of a plurality of levels (for example, two levels) of priorities for a certain signal or channel has been under study. For example, it is assumed that communication control (for example, transmission control at the time of collision or the like) is performed by configuring different priorities for each of the signals or channels respectively corresponding to different traffic types (also referred to as services, service types, communication types, use cases, or the like). With this, communication can be controlled by configuring different priorities depending on the service type or the like for the same signal or channel.

The priority may be configured for a signal (for example, UCI such as a HARQ-ACK, a reference signal, or the like), a channel (a PDSCH, a PUSCH, or the like), a HARQ-ACK codebook, or the like. The priority may be defined by a first priority (for example, High) and a second priority (for example, Low) of a priority lower than the first priority. Alternatively, three or more types of priorities may be configured. Information related to the priority may be notified from the base station to the UE, using at least one of higher layer signaling and DCI.

For example, the priority may be configured for a HARQ-ACK for a dynamically scheduled PDSCH, a HARQ-ACK for a semi-persistent PDSCH (SPS PDSCH), and a HARQ-ACK for SPS PDSCH release. Alternatively, the priority may be configured for HARQ-ACK codebooks corresponding to these HARQ-ACKs. Note that, when the priority is configured for the PDSCH, the priority of the PDSCH may be interpreted as the priority of the HARQ-ACK for the PDSCH.

When different UL signals/UL channels collide with each other, the UE may control UL transmission, based on the priority. For example, control may be performed such that UL transmission having a high priority is performed and UL transmission having a low priority is not performed (for example, dropped). Alternatively, transmission timing of the UL transmission having a low priority may be changed (for example, deferred or shifted).

The case in which different UL signals/UL channels collide with each other may be a case in which time resources (or time resources and frequency resources) of the different UL signals/UL channels overlap with each other, or a case in which transmission timings of the different UL signals/UL channels overlap with each other.

When the priority is notified using DCI, whether or not a bit field (for example, a Priority indicator) for giving a notification of the priority is configured for the DCI may be notified or configured from the base station to the UE using higher layer signaling. When the DCI does not include the bit field for giving a notification of the priority, the UE may determine that the priority of the PDSCH scheduled using the DCI (or the HARQ-ACK corresponding to the PDSCH) is a specific priority (for example, low).

### (Unlicensed Band)

In an unlicensed band (which may be referred to as an unlicensed spectrum, such as a 2.4 GHz band, a 5 GHz band, and a 6 GHz band, for example), for example, it is assumed that a plurality of systems, such as a Wi-Fi system and a system supporting Licensed-Assisted Access (LAA) (LAA system), coexist, and thus it is considered that collision avoidance and/or interference control in transmission between the plurality of systems is required.

In LAA of an existing LTE system (for example, Rel. 13), before transmitting data in the unlicensed band, a transmission apparatus of the data performs listening for confirming whether or not there is a transmission of another apparatus (for example, a base station, a user terminal, a Wi-Fi apparatus, or the like). The listening may be referred to as Listen Before Talk (LBT), Clear Channel Assessment (CCA), carrier sense, channel sensing, sensing, a channel access operation (channel access procedure), a shared spectrum channel access operation (shared spectrum channel access procedure), energy detection (ED), or the like.

The transmission apparatus may be, for example, a base station (which may be referred to as a gNodeB (gNB), or a network (NW), for example) in the downlink (DL), and a user terminal (UE) in the uplink (UL). A reception apparatus that receives the data from the transmission apparatus may be, for example, a user terminal in the DL, and a base station (NW) in the UL.

In LAA of an existing LTE system, the transmission apparatus starts data transmission after a certain period (for example, immediately after or a back-off period) has elapsed since it is detected that there is no transmission (idle state) of another apparatus in LBT.

Use of the unlicensed band has been under study in future radio communication systems (for example, also referred to as 5G, 5G+, New Radio (MR), 3GPP Rel. 15 or later versions, or the like) as well. An NR system using the unlicensed band may be referred to as an NR-Unlicensed (U) system, an NR LAA system, or the like.

Dual connectivity (DC) between a licensed band and an unlicensed band, stand-alone (SA) in an unlicensed band, and the like may also be included in NR-U.

A node (for example, the base station, the UE) in NR-U starts transmission after confirming that a channel is available (idle) using LBT due to coexistence with another system or another operator.

In NR-U, when LBT results indicate “idle”, the base station (for example, the gNB) or the UE gains a transmission opportunity (TxOP) and performs transmission. When the LBT results indicate “busy” (LBT-busy), the base station or the UE does not perform transmission. Time of the transmission opportunity may be referred to as channel occupancy time (COT).

Note that LBT-idle may be interpreted as LBT success. LBT-busy may be interpreted as LBT failure.

### (FBE/LBE)

In the future radio communication systems (for example, NR of Rel. 16 or later versions), a scheme in which the UE performs LBT based on a plurality of LBT types has been under study. As a mechanism for the LBT, FBE (frame-based equipment) may be used, or LBE (load-based equipment) may be used.

FBE may refer to an LBT mechanism having a fixed frame period, in which sensing is performed using a part of its resources, and transmission is performed when a channel is available, whereas transmission is deferred until the next sensing timing when a channel is unavailable.

In NR of Rel. 16 or later versions, when a specific higher layer parameter (for example, ChannelAccessMode-r16) is provided for the UE, and the specific higher layer parameter satisfies a specific condition (for example, “ChannelAccessMode-r16=semistatic” is configured), the NW and the UE may perform LBT, based on FBE. LBT based on FBE may be referred to as semi-static (semistatic) LBT, a semi-static channel access operation, a semi-static channel access mode, or the like.

In contrast, LBE may refer to an LBT mechanism in which, when a channel is unavailable as a result of sensing being performed, a sensing period is extended, and sensing is continuously performed until the channel becomes available.

In NR of Rel. 16 or later versions, when a specific higher layer parameter (for example, ChannelAccessMode-r16) is provided for the UE, and the specific higher layer parameter satisfies a specific condition (for example, “ChannelAccessMode-r16=dynamic” is configured, or ChannelAccessMode-r16 is not indicated), the NW and the UE may perform LBT, based on LBE.

LBT based on LBE may be referred to as dynamic LBT. LBT based on LBE may be classified depending on a type of LBT. The type of LBT may be referred to as a channel access type, a channel access mode, a shared channel access type, or the like.

In NR of Rel. 16 or later versions, the channel access type may be classified into one of type 1, type 2A, type 2B, and type 2C.

Terms of the channel access type are not limited to these. As the terms of the channel access type, for example, “channel access type X” X may be represented by any number, alphabet, or a combination of a number and an alphabet, or other terms may be used.

Type 1 channel access may be channel access having variable transmission standby time (contention window size (CWS)) with random back-off. Type 1 channel access may be a channel access type used in a coexistence environment with another unlicensed band (for example, Wi-fi).

In type 1 channel access, the terminal (including a terminal in another radio communication standard)/gNB may perform sensing in a specific period before transmission of a signal. The specific period at least may include an extended period (which may be referred to as Defer duration, for example, 43 μs) and a sensing slot (for example, 9 μs).

In type 1 channel access, when the terminal/gNB is configured with a specific counter (timer), and the counter expires (a value of the counter is 0), transmission of a signal may be permitted.

The counter may be decremented every time one sensing slot (for example, 9 μs) elapses. When transmission of a signal by a terminal/gNB other than the terminal/gNB is detected (case of LBT busy), the counter configured for the terminal/gNB may be stopped in a specific period (a period in which the signal is transmitted). The counter may be started again after the specific period (the period in which the signal is transmitted) has elapsed.

When the value of the counter configured for a plurality of terminals/gNBs becomes 0 at a certain moment, and transmissions of signals of the plurality of terminals/gNBs overlap, the CWS of the terminal may be extended.

Type 2A channel access may be channel access without random back-off. In type 2A channel access, the UE may be configured with a first period (for example, a period (which may be referred to as a sensing period (interval), a gap, or the like) of 25 μs) including a period in which sensing is performed, and perform sensing in the period. In a case of LBT idle in the sensing, the UE may perform transmission of a signal immediately after the period has elapsed.

Type 2B channel access may be channel access without random back-off. In type 2B channel access, the UE may be configured with a second period (for example, a period of 16 μs) including a period in which sensing is performed, and may perform sensing in the period. In a case of LBT idle in the sensing, the UE may perform transmission of a signal immediately after the period has elapsed.

Type 2C channel access may be channel access in which, although the UE is configured with a period equal to or less than the first period or the second period (for example, 16 μs), sensing is not performed in the period. The UE may perform transmission of a signal in a certain period (for example, a period of 584 μs at most) immediately after the period has elapsed.

In order to control the period in which sensing is performed in each type of channel access, cyclic prefix (CP) extension may be configured. CP extension may be indicated by specific time corresponding to a CP extension index. The specific time may be at least one of 25 μs, 16+T_{TA} μs, and 25+T_{TA} μs, where T_{TA} represents timing advance.

The UE may receive information related to an indication of the channel access type and the CP extension, based on at least one of higher layer signaling and physical layer signaling.

In LBT based on FBE of Rel. 16 or earlier versions, the base station and the UE perform transmission and reception of an uplink (UL)/downlink (DL) signal/channel by using base station-initiated (gNB-initiated) COT. In the present disclosure, the base station-initiated COT may be COT obtained as a result of a certain base station (NW) having performed sensing. The base station-initiated COT may be referred to as COT initiated by the base station.

In Rel. 16 or earlier versions, the base station-initiated COT may be included in a fixed frame period (FFP). The FFP may be referred to as periodic channel occupancy (PCO) or semi-static channel occupancy (SCO). A starting position of the FFP for each set of two consecutive radio frames may be aligned with a starting position of a specific radio frame (having an even-numbered index, for example).

The period of the FFP may be configured for/notified to the UE, via higher layer signaling. The higher layer signaling may be System Information Block 1 (SIB1) signaling/RRC signaling. A higher layer parameter configured/notified via the higher layer signaling may be SemiStaticChannelAccessConFIG. The period may be determined out of 1 ms, 2 ms, 2.5 ms, 4 ms, 5 ms, and 10 ms, for example.

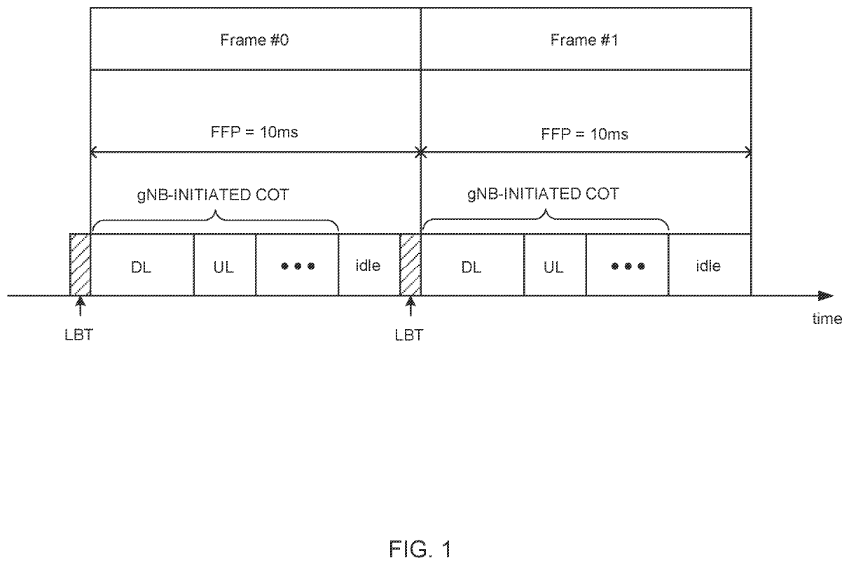

FIG. 1 is a diagram to show an example of base station-initiated COT in Rel. 16. The base station (gNB) performs sensing in a specific period (which may be referred to as a sensing slot, for example) immediately before start of the FFP. The FFP may include COT, a specific idle period in which transmission and reception of a signal/channel are not performed, and a period (which may be referred to as a sensing slot) in which sensing is performed.

As a result of the sensing, if LBT succeeds, the gNB obtains COT (gNB-initiated COT). The COT is included in the FFP (here, a period of 10 ms), and the starting position of the COT is aligned with the starting position of the FFP. The starting position of the FFP is aligned with the starting position of each radio frame (here, frame #0 and frame #1). The gNB performs transmission of a DL signal/channel and transmission of a UL signal/channel in the obtained COT.

Note that, in the gNB-initiated COT, the gNB may first perform transmission of a DL signal/channel. In other words, in the gNB-initiated COT, the UE may first perform reception of a DL signal/channel.

In addition, in Rel. 17 or later versions, in order to use the semi-static channel access mode, a study has been carried out on a scheme in which a specific channel/signal using the UE-initiated COT is supported in a state (for example, an RRC CONNECTED mode) in which RRC connection of the UE has completed. In contrast, a study has not been carried out on whether or not the UE-initiated COT is used and for which channel/signal the UE-initiated COT is used in a state in which RRC connection of the UE has not completed (for example, an IDLE mode, an INACTIVE mode, an IDLE/INACTIVE mode).

In Rel. 17 or later versions, a study has been carried out on a scheme in which, only when a higher layer parameter for applying the semi-static channel occupancy (SCO) initiated by the gNB is notified to/configured for the UE for a certain channel/signal using the unlicensed band, the UE is configured with the UE-initiated COT for the channel/signal. Note that a configuration of FBE initiated by the UE may be performed for each serving cell.

In Rel. 17 or later versions, a study has been carried out on a scheme in which the FFP for the UE-initiated COT and the FFP for the gNB-initiated COT are separately configured in the semi-static channel access mode. Note that a value of the FFP may be any value from 1 ms to 10 ms.

Incidentally, in the future radio communication systems (for example, NR of Rel. 17 or later versions), in order to further improve high-reliable and low-latency communication (for example, a traffic type such as URLLC), a study has been carried out on introduction of the UE-initiated COT for FBE. However, a full study has not been carried out on the UE-initiated COT.

Specifically, a full study has not been carried out on whether the UE in the IDLE/INACTIVE mode can obtain the UE-initiated COT, that is, whether the UE can obtain the COT by using a physical random access channel (PRACH). Neither has a full study been carried out on an operation when the UE in the IDLE/INACTIVE mode obtains the COT by using the PRACH. As the operation, for example, coexistence with the UE supporting NR-U in Rel. 16 and a configuration of the PRACH/FFP are considered.

Note that the UE supporting NR-U in Rel. 16 may transmit the PRACH in a period (RACH occasion (RO)) for transmitting the PRACH in the base station-initiated COT. In Rel. 16, a configuration related to the FFP of the base station-initiated COT and a configuration related to the PRACH in the base station-initiated COT may be notified/configured via higher layer signaling (for example, SIB1/RRC signaling).

The configuration related to the PRACH may be a parameter (for example, rach-ConfigCommon) for the RACH configuration included in an SIB (for example, ServingCellConfigCommonSIB) for a serving cell configuration. The parameter (for example, channelAccessMode-r16) for configuring the channel access mode may be included in the SIB (for example, ServingCellConfigCommonSIB) for the serving cell configuration, and the channel access mode and the RACH configuration may be associated with each other.

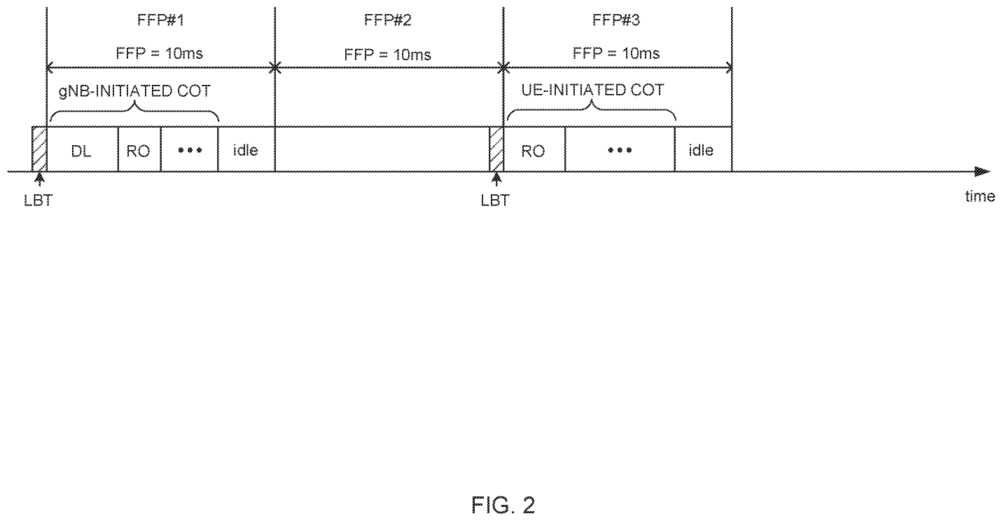

FIG. 2 is a diagram to show an example of obtaining the UE-initiated COT. In the example shown in FIG. 2, the UE obtains the COT (UE-initiated COT) in FFP #3. For example, the UE may be configured with the RO in the COT, perform PRACH transmission in the RO, and obtain the COT.

With the study related to the UE-initiated COT being not fully carried out, when a traffic type such as URLLC is used in an NR-U system, throughput may be reduced or communication quality may be deteriorated.

In view of this, the inventors of the present invention came up with the idea of a method of configuring the UE-initiated COT/FFP when a traffic type such as URLLC is used in the NR-U system.

Embodiments according to the present disclosure will be described in detail with reference to the drawings as follows. The radio communication methods according to respective embodiments may each be employed individually, or may be employed in combination.

In the present disclosure, “A/B” may be interchangeably interpreted as at least one of A and B, and “A/B/C” as at least one of A, B, and C.

In the present disclosure, gNB-initiated COT may be referred to as first COT, semi-static COT in FBE, COT initiated by the gNB, or the like. In the present disclosure, the FFP for the gNB-initiated COT may be referred to as an FFP for the first COT, an FFP included in the first COT, a first FFP, an FFP for the semi-static COT in FBE, or the like.

In the present disclosure, the UE-initiated COT may be referred to as second COT, dynamic COT in FBE, COT initiated by the UE, or the like. In the present disclosure, the FFP for the UE-initiated COT may be referred to as an FFP for the second COT, an FFP included in the second COT, a second FFP, an FFP for the dynamic COT in FBE, or the like.

In the present disclosure, “the UE obtains the COT” may be interpreted as “to obtain the UE-initiated COT”, “to obtain the COT initiated by the UE”, “the UE performs COT initiation”, “the UE initiates the COT”, or the like.

In the present disclosure, the UE that has not completed RRC connection, the UE in the IDLE mode, the UE in the INACTIVE mode, and the UE in the IDLE/INACTIVE mode may be interchangeably interpreted as each other, or may be simply referred to as the UE.

In the present disclosure, a period for transmitting the PRACH may be interpreted as a PRACH transmission period, a PRACH transmission opportunity, a transmission opportunity, a RACH occasion, or the like.

In the present disclosure, to initiate the COT by using the PRACH may mean to initiate the COT by using the configuration related to the PRACH, to initiate the COT based on the configuration related to the PRACH, to transmit the PRACH in the initiated COT, or the like.

### Radio Communication Method

### First Embodiment

The UE in the IDLE/INACTIVE mode may perform COT initiation by using the configuration related to the PRACH defined in Rel. 16 or earlier versions. In other words, the UE may perform transmission of the PRACH in the UE-initiated COT, based on the configuration related to the PRACH in the base station-initiated COT. In a first embodiment, COT initiation and PRACH transmission may be performed in accordance with at least one of the following embodiments 1-1 and 1-2.

### Embodiment 1-1

The UE may receive a configuration (configuration information) related to the FFP (second FFP) used for COT initiation, via higher layer signaling.

The configuration related to the FFP may be at least one of information related to a period of the UE-initiated COT and information related to a UE-initiated starting position (offset). The higher layer signaling may be, for example, at least one of SIB1 and RRC signaling.

In the present disclosure, the starting position and the period of the second FFP may be determined based on the first FFP.

For example, the starting position and the period of the second FFP in a specific period (for example, a specific frame) may be the same as the starting position and the period of the first FFP in the specific period, respectively. In other words, the UE may perform transmission and reception of a signal/channel in the COT included in the second FFP having the same starting position and period as those of the first FFP.

In the present disclosure, information related to a period of the second FFP may be configured for/notified to the UE, via a higher layer parameter (for example, SemiStaticChannelAccessConfig) on higher layer signaling (SIB1 signaling/RRC signaling). The period may be determined out of 1 ms, 2 ms, 2.5 ms, 4 ms, 5 ms, and 10 ms, for example, may be represented by an integer multiple of a specific period (for example, a slot, a sub-slot, a symbol, or a subframe), or may be represented by any time.

In the present disclosure, the UE may receive the information related to the period of the second FFP, based on a specific field included in DCI for scheduling transmission of a UL signal/channel in the second COT. The DCI may be DCI included in the first COT.

In the present disclosure, the UE may be notified of/configured with a set (list) of pieces of information related to the period of the second FFP, via higher layer signaling. Next, the UE may select (determine), out of the set, a piece of information related to the period of the second FFP to be applied to the second COT, based on a specific field included in DCI for scheduling transmission of a UL signal/channel in the second COT. The DCI may be DCI included in the first COT.

In embodiment 1-1, when the starting position of the second FFP and the starting position of the RACH occasion (RO) are aligned, the UE may perform COT initiation by using the configuration related to the PRACH. Transmission of the PRACH may conform to a PRACH transmission method defined in releases earlier than Rel. 16.

### Embodiment 1-2

The UE may receive a configuration as to whether or not to perform COT initiation, via higher layer signaling.

The configuration as to whether or not to perform COT initiation may be determined by the UE with a specific higher layer parameter being configured to either “enable” or “not enable” or “disable” for the UE, or may be determined by the UE based on whether or not the specific higher layer parameter is configured to “enable” for the UE. The higher layer signaling may be, for example, at least one of SIB1 and RRC signaling.

In embodiment 1-2, when the UE is configured to perform COT initiation, the UE may perform COT initiation by using the configuration related to the PRACH. Transmission of the PRACH may conform to a PRACH transmission method defined in releases earlier than Rel. 16.

In embodiment 1-2, the UE may assume that the length of the UE-initiated COT is related to the RO in the COT. For example, the UE may assume that the length of the UE-initiated COT matches the RO in the COT. For example, the UE may assume that the COT ends at a time point when transmission of the PRACH ends.

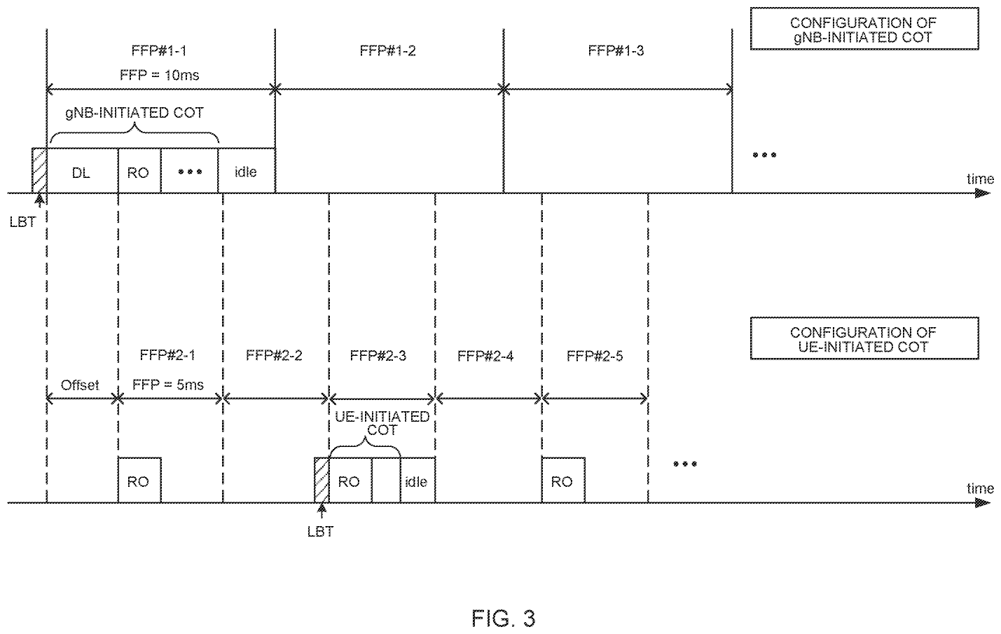

FIG. 3 is a diagram to show an example of the PRACH transmission period in the COT according to the first embodiment. FIG. 3 shows an example of embodiment 1-1 described above. In the example shown in FIG. 3, each of the FFP (the first FFP, FFPs #1-1 to #1-3) for the gNB-initiated COT and the FFP (the second FFP, FFPs #2-1 to #2-5) for the UE-initiated COT is configured. In the example shown in FIG. 3, the period of the first FFP is 10 ms, and the period of the second FFP is 5 ms. The start (FFP #2-1) of the second FFP is started after a specific offset from the start (FFP #1-1) of the first FFP. In the gNB-initiated COT, the RO is configured. The UE may assume that the start of the RO in the configuration of the gNB-initiated COT and the start of the RO in the configuration of the UE-initiated COT are aligned.

In the example shown in FIG. 3, the UE receives, from the gNB, the configuration information related to the FFP for the UE-initiated COT. Next, the UE obtains the COT in FFP #2-3, and transmits the PRACH in the RO in the COT.

According to the first embodiment described above, PRACH transmission in the UE-initiated COT compatible with operation configurations of Rel. 16 is enabled.

### Second Embodiment

The UE in the IDLE/INACTIVE mode may perform COT initiation by using a PRACH configuration different from the configuration related to the PRACH defined in Rel. 16 or earlier versions. In other words, the UE may receive information related to the PRACH in the UE-initiated COT. In a second embodiment, COT initiation and PRACH transmission may be performed in accordance with at least one of the following embodiments 2-1 and 2-2.

### Embodiment 2-1

The UE may receive a configuration (FFP configuration information) related to the FFP (second FFP) used for COT initiation and a configuration related to the PRACH for the UE-initiated COT, via higher layer signaling.

The configuration related to the FFP may be at least one of information related to a period of the UE-initiated COT and information related to a UE-initiated starting position (offset). The configuration related to the PRACH may be different from a higher layer parameter for the configuration of the PRACH in the gNB-initiated COT defined in releases earlier than Rel. 16. In other words, a higher layer parameter for the configuration of the PRACH associated with the configuration related to the second FFP configured for the UE may be notified to the UE. The higher layer signaling may be, for example, at least one of SIB1 and RRC signaling.

In embodiment 2-1, when the starting position of the second FFP and the starting position of the RACH occasion (RO) are aligned, the UE may perform COT initiation by using the configuration related to the PRACH. Transmission of the PRACH may conform to a PRACH transmission method defined in Rel. 16.

### Embodiment 2-2

The UE may receive a configuration as to whether or not to perform COT initiation, via higher layer signaling.

The configuration as to whether or not to perform COT initiation may be determined by the UE with a specific higher layer parameter being configured to either “enable” or “not enable” or “disable” for the UE, or may be determined by the UE based on whether or not the specific higher layer parameter is configured to “enable” for the UE. The higher layer signaling may be, for example, at least one of SIB1 and RRC signaling.

In embodiment 2-2, when the UE is configured to perform COT initiation, the UE may perform COT initiation by using the configuration related to the PRACH. Transmission of the PRACH may conform to a PRACH transmission method defined in Rel. 16.

In embodiment 2-2, the UE may assume that the length of the UE-initiated COT is related to the RO in the COT. For example, the UE may assume that the length of the UE-initiated COT matches the RO in the COT. For example, the UE may assume that the COT ends at a time point when transmission of the PRACH ends.

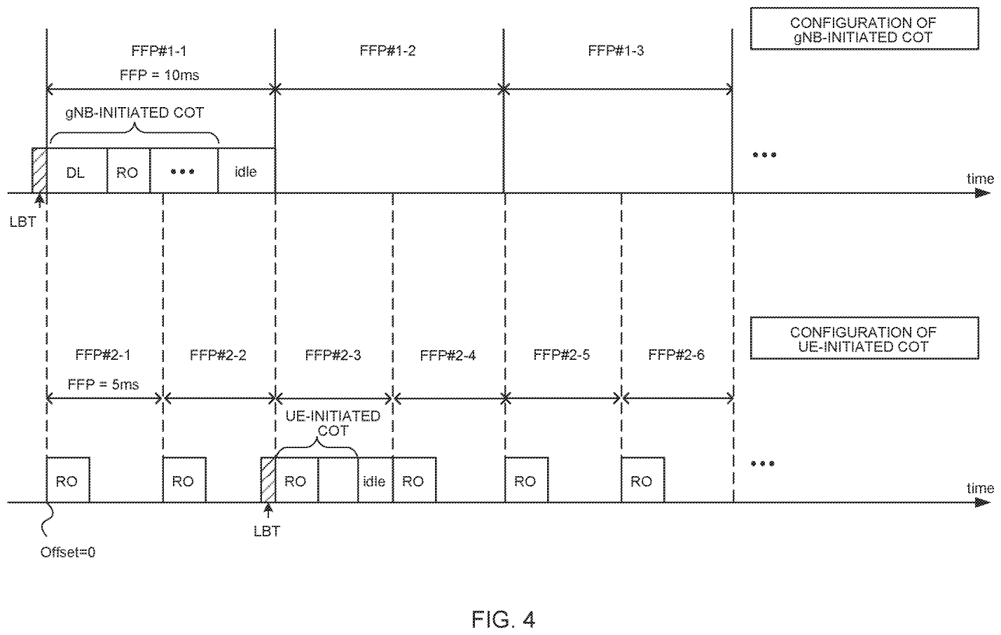

FIG. 4 is a diagram to show an example of the PRACH transmission period in the COT according to the second embodiment. FIG. 4 shows an example of embodiment 2-1 described above. In the example shown in FIG. 4, each of the FFP (the first FFP, FFPs #1-1 to #1-3) for the gNB-initiated COT and the FFP (the second FFP, FFPs #2-1 to #2-6) for the UE-initiated COT is configured. The period of the first FFP is 10 ms, and the period of the second FFP is 5 ms. In the example shown in FIG. 4, the offset of the start (FFP #2-1) of the second FFP is configured to 0, and is aligned with the start (FFP #1-1) of the first FFP. In the gNB-initiated COT, the RO is configured. The UE may assume that the start of the RO in the configuration of the gNB-initiated COT and the start of the RO in the configuration of the UE-initiated COT are not aligned.

In the example shown in FIG. 4, the UE receives, from the gNB, configuration information related to the FFP for the UE-initiated COT and configuration information related to the PRACH for the UE-initiated COT. Next, the UE obtains the COT in FFP #2-3, and transmits the PRACH in the RO in the COT.

According to the second embodiment described above, PRACH transmission in the UE-initiated COT can be flexibly controlled.

### Third Embodiment

A higher layer parameter (RRC information element)/UE capability corresponding to at least one function (characteristic, feature) in the first and second embodiments may be defined. The UE capability may indicate support of the function.

The UE configured with the higher layer parameter corresponding to the function may perform the function. “The UE not configured with the higher layer parameter corresponding to the function does not perform the function” may be defined.

The UE that has reported the UE capability indicating support of the function may perform the function. “The UE that does not report the UE capability indicating support of the function does not perform the function” may be defined.

When the UE reports the UE capability indicating support of the function, and is configured with the higher layer parameter corresponding to the function, the UE may perform the function. “When the UE does not report the UE capability indicating the support of the function, or is not configured with the higher layer parameter corresponding to the function, the UE does not perform the function” may be defined.

The function may be to obtain the UE-initiated COT using the PRACH.

The function may be a basic feature of the UE in a specific scenario (for example, at least one of LAA, CA, DC, and SA). The basic feature of the UE in a specific scenario may mean a function that is invariably supported by the UE supporting the specific scenario.

According to the third embodiment described above, the UE can implement the functions while keeping compatibility with existing specifications.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

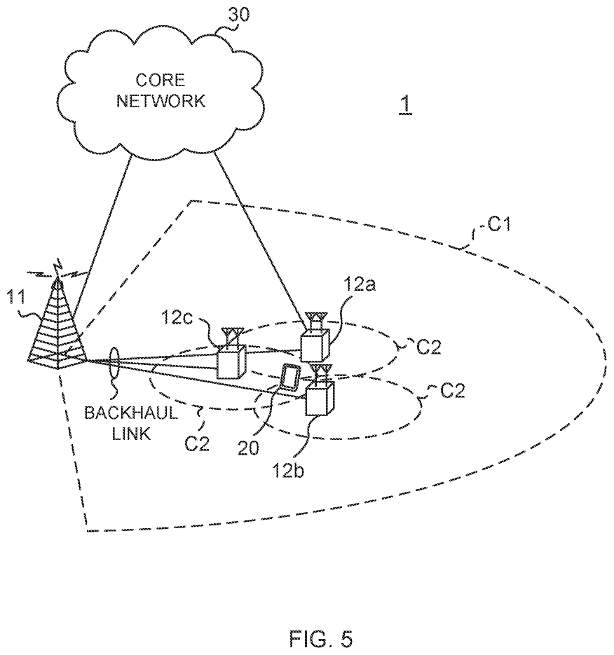

FIG. 5 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations (for example, RRHs) 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

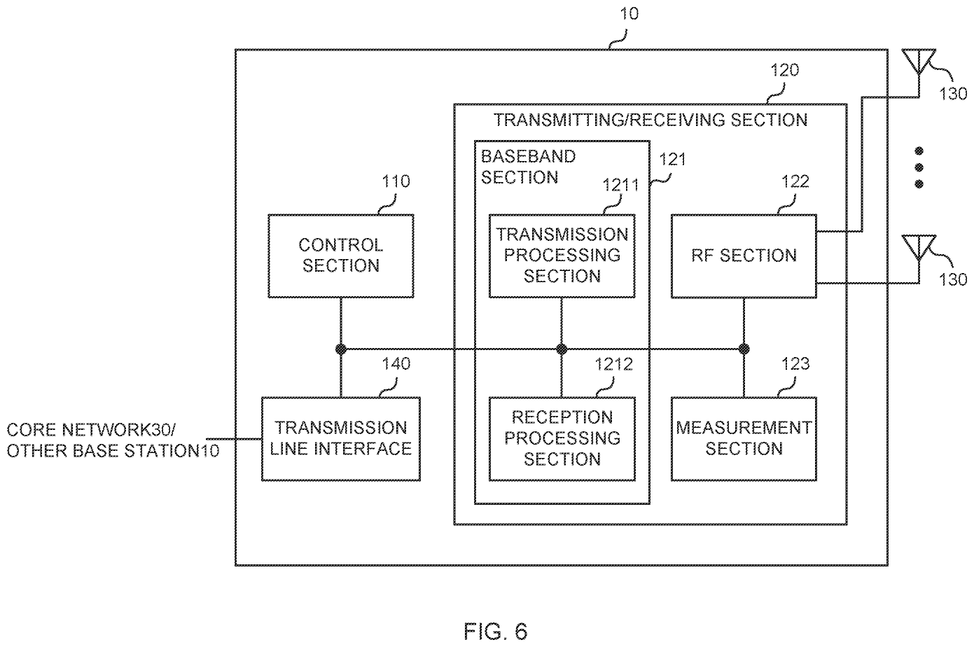

FIG. 6 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RPM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit configuration information related to channel occupancy time (COT) in a semi-static channel access procedure and configuration information related to a physical random access channel (PRACH), via higher layer signaling. The control section 110 may control reception of the PRACH transmitted based on the configuration information related to the PRACH in a PRACH transmission opportunity in the COT initiated based on the configuration information related to the COT (first and second embodiments).

### (User Terminal)

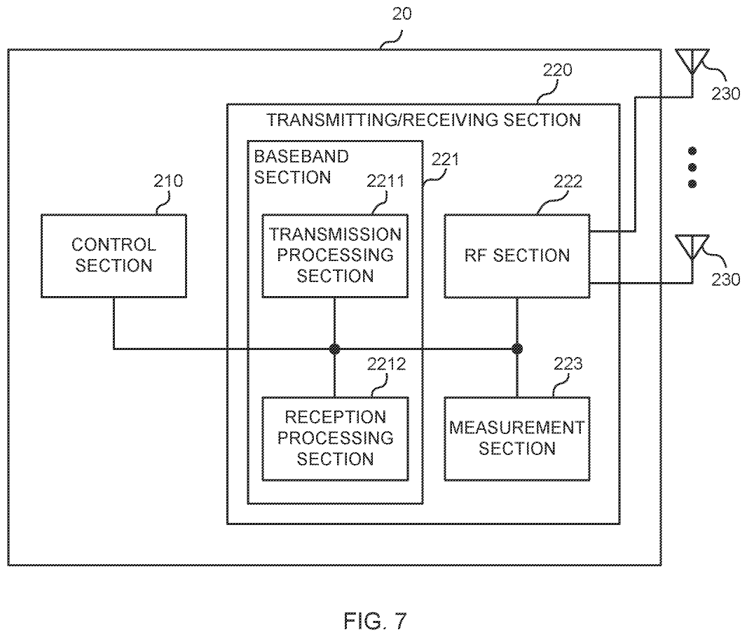

FIG. 7 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive configuration information related to channel occupancy time (COT) in a semi-static channel access procedure and configuration information related to a physical random access channel (PRACH), via higher layer signaling. The control section 210 may control initiation of the COT, based on the configuration information related to the COT, and may control PRACH transmission in a PRACH transmission opportunity in the COT, based on the configuration information related to the PRACH (first and second embodiments).

The configuration information related to the COT may be at least one of information for giving notification of a starting position and a period of the COT and information for configuring the initiation of the COT to “enable” (first embodiment).

The configuration information related to the PRACH may be based on information related to the PRACH in the COT initiated by a base station (first and second embodiments).

The configuration information related to the PRACH and information related to the PRACH in the COT initiated by a base station may be separately notified (first and second embodiments)

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

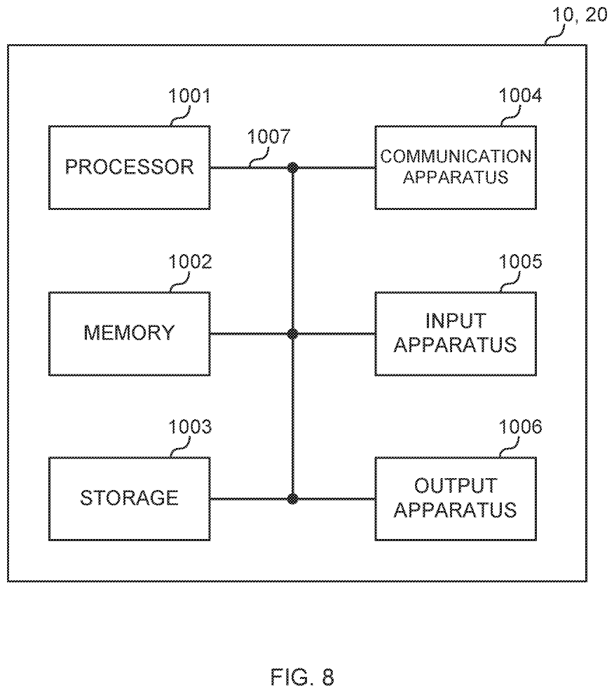

For example, a base station, a user terminal, and so on according to one embodiment of the present disclosure may function as a computer that executes the processes of the radio communication method of the present disclosure. FIG. 8 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

The present application is based on Japanese Patent Application No. 2021-009744 filed on Jan. 25, 2021, the entire contents of which are incorporated herein by reference.

1. A terminal comprising:
a receiving section that receives configuration information related to channel occupancy time (COT) in a semi-static channel access procedure and configuration information related to a physical random access channel (PRACH), via higher layer signaling; and
a control section that controls initiation of the COT, based on the configuration information related to the COT, and controls PRACH transmission in a PRACH transmission opportunity in the COT, based on the configuration information related to the PRACH.

2. The terminal according to claim 1, wherein
the configuration information related to the COT is at least one of information for giving notification of a starting position and a period of the COT and information for configuring the initiation of the COT to “enable”.

3. The terminal according to claim 1, wherein
the configuration information related to the PRACH is based on information related to the PRACH in the COT initiated by a base station.

4. The terminal according to claim 1, wherein
the configuration information related to the PRACH and information related to the PRACH in the COT initiated by a base station are separately notified.

5. A radio communication method for a terminal, the radio communication method comprising:
receiving configuration information related to channel occupancy time (COT) in a semi-static channel access procedure and configuration information related to a physical random access channel (PRACH), via higher layer signaling; and
controlling initiation of the COT, based on the configuration information related to the COT, and controlling PRACH transmission in a PRACH transmission opportunity in the COT, based on the configuration information related to the PRACH.

6. A base station comprising:
a transmitting section that transmits configuration information related to channel occupancy time (COT) in a semi-static channel access procedure and configuration information related to a physical random access channel (PRACH), via higher layer signaling; and
a control section that controls reception of the PRACH transmitted based on the configuration information related to the PRACH in a PRACH transmission opportunity in the COT initiated based on the configuration information related to the COT.
